(19) United States
(12) Patent Application Publication
(10) Pub. No.: US 2021/0196083 A1
(43) Pub. Date: Jul. 1, 2021

(54) WORKSTATION SINK

(71) Applicant: Peter Raleigh, Warwick, NY (US)

(72) Inventor: Peter Raleigh, Warwick, NY (US)

(21) Appl. No.: 17/135,875

(22) Filed: Dec. 28, 2020

Related U.S. Application Data
(60) Provisional application No. 62/953,791, filed on Dec. 26, 2019.

(51) Int. Cl. A47J 47/20; E03C 1/182; A47J 43/24; A47J 47/00

(52) U.S. Cl. CPC A47J 47/20; A47J 47/005; A47J 43/24; E03C 1/182

(57) ABSTRACT

A workstation sink includes a bi-level ledge for supporting food preparation accessories at different elevations. Foods being prepared at an accessory such as a chopping board supported from an upper level of the ledge can be easily transferred to a further accessory, such as a colander or rack, supported from a lower level of the ledge. Further, rinsing or washing accessories on the upper level reduces splashing because the rinse water descends to the drain at the lower level.

### BACKGROUND OF THE INVENTION

### Field of the Invention

The present invention relates generally to kitchen equipment and more specifically to an improved workstation sink.

### Antecedents of the Invention

With the development of workstation or ledge sinks, the usefulness of sinks has vastly improved by incorporating a variety of features and platforms expediting food preparation tasks.

While a workstation sink may appear similar to other standard kitchen sinks there are many more functionalities provided by accessories supported by a built in ledge. The ledge Along with the sink comes many more accessories that add the functionalities. An integral ledge in the sink provides a support surface for accessories such as cutting boards, drain mats, colanders, trays, soaking vessels, colanders, drain grids etc. which may be slid across the ledge.

With a planar ledge across the entire width to the workstation sink, certain disadvantages have been encountered, however. For example, wilt all accessories at the same planar level foods prepared on a chopping board could not be easily transferred to a colander or rack positioned at the same level, without inadvertent spillage into the underlying sink cavity.

### SUMMARY OF THE INVENTION

A workstation sink includes a bi-level ledge for supporting food preparation accessories at different elevations. Foods being prepared at an accessory such as a chopping board supported from an upper level of the ledge can be easily transferred to a further accessory, such as a colander or rack, supported from a lower level of the ledge.

From the foregoing compendium, it will be appreciated that an aspect of the present invention is to provide a workstation sink of the general character described which is not subject to the aforementioned disadvantages of the antecedents of the invention.

A feature of the present invention is to provide a workstation sink of the general character described which is readily adaptable for use in households as well as commercial food preparation establishments.

A consideration of the present invention is to provide a workstation sink of the general character described which is simple to use.

Another feature of the present invention is to provide a workstation sink of the general character described which promotes efficient food preparation.

A further aspect of the present invention is to provide a workstation sink of the general character described which is well suited for mass production fabrication.

Another feature of the present invention is to provide a workstation sink of the general character described which includes bi-level ledges.

Other aspects, features and considerations of the present invention in part will be obvious and in part will be pointed out hereinafter.

With these ends in view, the invention finds embodiment in various combinations of elements, arrangements of parts and series of steps by which the above-mentioned aspects, features and considerations and certain other aspects, features and considerations are attained, or with reference to the accompanying drawings and the scope of which will be more particularly pointed out and indicated in the appended claims.

### BRIEF DESCRIPTION OF THE DRAWINGS

The purpose and advantages of the present invention will be apparent to those of skill in the art from the following detailed description in conjunction with the appended drawings in which like reference characters are used to indicate like elements, and in which:

FIG. 1 is an isometric view of a workstation sink constructed in accordance with and embodying the invention and showing a bi-level ledge for supporting accessories, with the sink oriented such that the upper level is to the user's right; it should be noted that the workstation sink can be mounted with the upper level to the user's left, i.e. rotated 180°;

FIG. 2 is a reduced scale plan view of the workstation sink:

FIG. 3 is a longitudinal sectional view through the workstation sink, the same taken along the plane 3-3 of FIG. 2;

FIG. 4 is an enlarged scale transverse sectional view through the workstation sink, the same being taken along the plane 4-4 of FIG. 3;

FIG. 5 is an enlarged scale transverse sectional view through the workstation sink, the same being taken along the plane 5-5 of FIG. 3; and

FIG. 6 is a perspective depiction of the workstation sink with a cutting or chopping block supported from an upper level of the bi-level ledge with a colander and rack supported from the lower level.

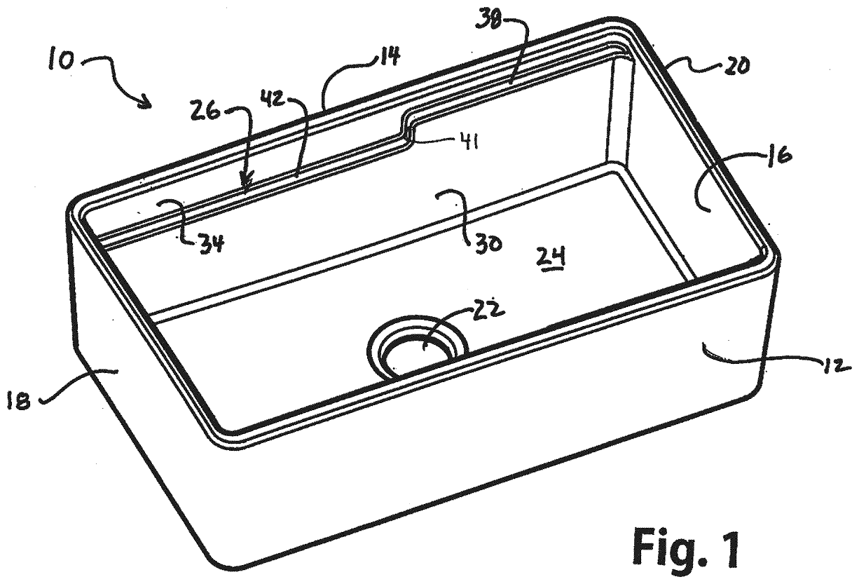

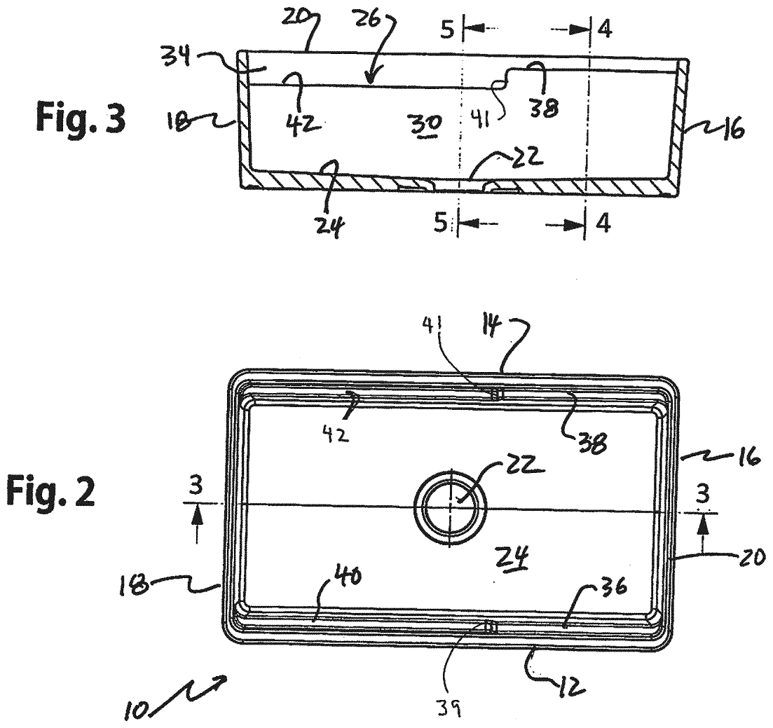

### DETAILED DESCRIPTION

The present invention will now be described in detail with reference to the illustrations which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements.

Moreover, where certain elements of the present invention can be partially or fully implemented using known components, only those portions of such known components that are necessary for an understanding of the present invention will be described, and detailed descriptions of other portions of such known components will be omitted so as not to obscure the invention.

Referring now in detail to the drawings, the reference nominal 10 denotes generally a workstation sink constructed in accordance with and embodying the invention. The workstation sink 10 is preferably formed of a granite-quartz composition or fireclay and is of rectangular configuration including a front or apron panel 12, a generally parallel rear panel 14 a right side panel 16 and a left side panel 18, all of which include a coplanar top edge 20. A sink drain opening 22 is provided in a bottom or base 24. The workstation sink 10 is oriented for mounting with the panel 12 facing the user; however it may be rotated 180° and mounted with the panel 14 facing the user.

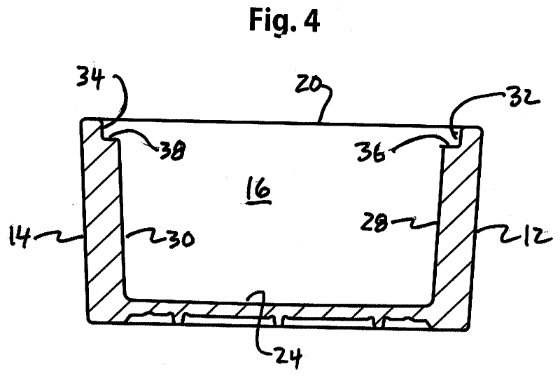

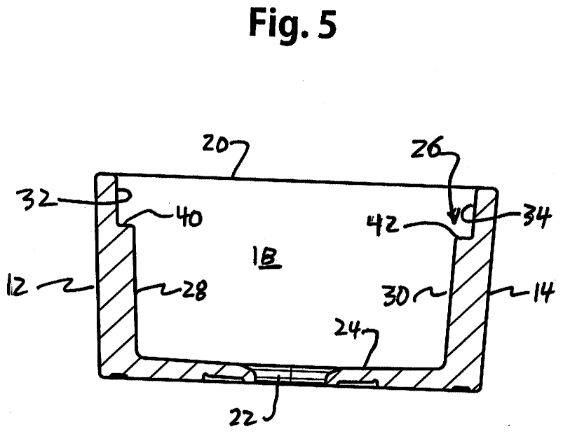

Pursuant to the invention, the workstation sink 10 is formed with a bi-level ledge 26 extending along the inner walls of the panels 12, 14. As will be noted from an examination of FIG. 4 and FIG. 5, the inner wall of the panel 12 includes a lower portion 28 which extends upwardly from the bottom 24 and the inner wall of the panel 14 includes a lower portion 30 which extends upwardly from the bottom 24.

The inner wall of the panel 12 includes an upper portion 32 which extends downwardly from the top edge 20 and the inner wall of the panel 14 includes a upper portion 34 which extends downwardly from the top edge 20.

The bi-level ledge 26 transitions between the lower portions 28, 30 and their respective upper portions 32, 34 and includes an elevated ledge portion 36, 38 on the inner face of the front and rear panels 12, 14 respectively. The elevated ledge portions 36, 38 of the bi-level ledge 26 extend substantially parallel to the top edge 20 from the right side panel 16 toward the left side panel 18 and terminate at steps 39, 41 respectively. Lower ledge portions 40, 42 extend substantially parallel to the top edge 20 from the steps 39, 41 to the left side panel 18.

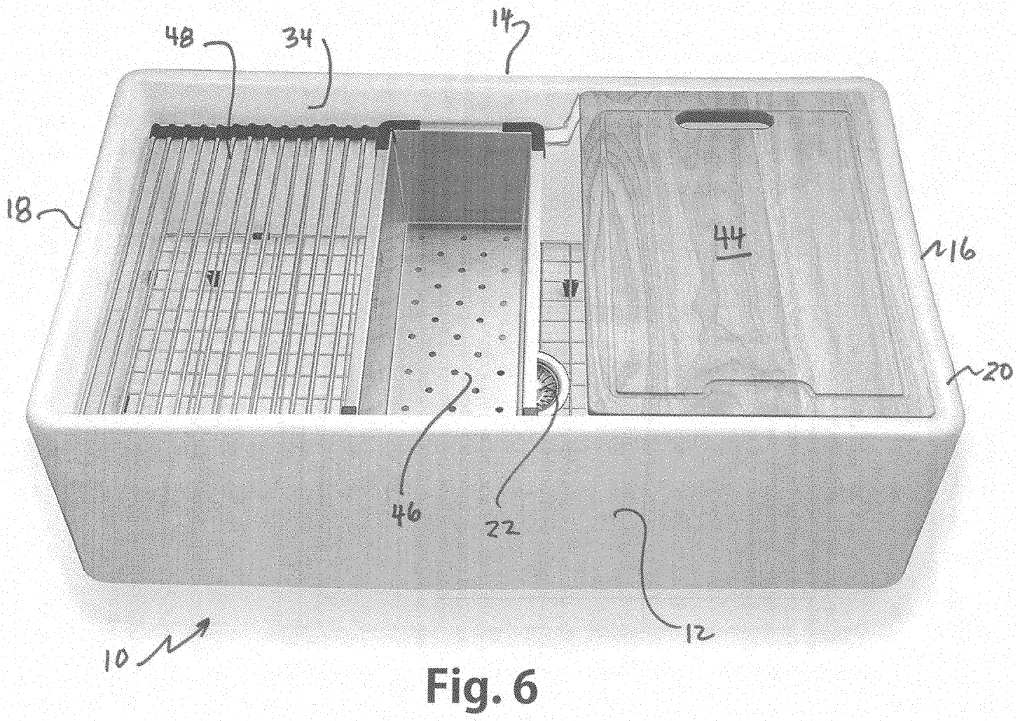

With reference to FIG. 6, it will be seen that foods being prepared at a cutting board 44, supported from the elevated ledge portions 36, 38 can be easily transferred to an accessory such as a colander 46 or rack 48 supported from the lower ledge portions 40, 42. A further option may be to wash food on the left side with or without accessories on the lower level ledge portions 40, 42, so as to reduce the possibility of splashing water on the cutting board or elevated food preparation surface supported from the elevated ledge portions 36, 38. The elevated ledge portions 36, 38 may also be employed to support a drying rack, for example, while washing cookware, utensils, dishes, etc., on the left side so as to reduce the possibility of splashing water on items in the drying rack.

The particular combinations of elements and features in the above-detailed embodiment are exemplary only; the interchanging and substitution of these teachings with other teachings in this application are also expressly contemplated. As those skilled in the art will recognize, variations, modifications, and other implementations of what is described herein can occur to those of ordinary skill in the art without departing from the spirit and the scope of the invention as claimed. For example, the workstation sink need not be formed of a granite-quartz composition or fireclay but may be fabricated of other conventional materials including stainless steel as well as plastics and porcelain.

Further, in describing the invention and in illustrating embodiments of the invention in the figures, specific terminology, numbers, dimensions, materials, etc., are used for the sake of clarity. However the invention is not limited to the specific terms, numbers, dimensions, materials, etc. so selected, and each specific term, number, dimension, material, etc., at least includes all technical and functional equivalents that operate in a similar manner to accomplish similar purpose. Use of a given word, phrase, number, dimension, material, language terminology, product brand, etc. is intended to include all grammatical, literal, scientific, technical, and functional equivalents. The terminology used herein is for the purpose of description and not limitation.

Having described the preferred embodiments of the invention, it will now become apparent to one of ordinary skill in the art that other embodiments incorporating the concept may be used. Moreover, those of ordinary skill in the art will appreciate that the embodiment of the invention described herein can he modified to accommodate and/or comply with changes and improvements in the applicable technology and standards referred to herein.

Thus it will be seen that there is provided a workstation sink which achieves the various aspects, features and considerations of the present invention which is well suited to meet the conditions of practical usage.

Having thus described the invention there is claimed as new and desired to be secured by Letters Patent:

1. A workstation sink comprising an upper peripheral edge, a pair of opposed substantially parallel inner walls extending in a generally vertical direction from the peripheral edge to a bottom, each inner wall including a ledge positioned beneath the upper peripheral edge for supporting food preparation accessories, each ledge including a first portion and a second portion, the first portion extending inwardly from the inner wall at distance beneath the peripheral edge less than that of the second portion whereby accessories supported from the ledge can be positioned at different elevations.

2. The workstation sink in accordance with claim 1 wherein the workstation sink includes side panels and the peripheral edge is substantially rectangular.

3. The workstation sink in accordance with claim 1 further including accessories selected from the group consisting of a cutting board, a chopping board, a colander, a drying rack, a drain grid, a soaking vessel and a tray.

4. The workstation sink in accordance with claim 1 wherein the workstation sink is composed of a granite-quartz composition or fireclay.

5. The workstation sink in accordance with claim 1 wherein each inner wall includes a lower portion extending upwardly from the bottom and an upper portion which extends downwardly from the peripheral edge with the ledge transitioning between the upper portions and the lower portions.

6. The workstation sink in accordance with claim 5 wherein the lower portion of each inner wall is thicker than the lower portion.

7. The workstation sink in accordance with claim 5 wherein the ledge transitions at a step descending from the upper portion to the lower portion.

8. A method of food preparation comprising the following steps:
a) providing a workstation sink in accordance with claim 1;
b) positioning a cutting block on the first portion of the ledge and a colander on the second portion of the ledge:
c) placing unprepared food suitable for cutting or chopping on the cutting block;
d) cutting or chopping the unprepared food;
e) sliding the chopped or cut food from the cutting block to the colander; and
f) rinsing the chopped or cut food within the colander.

9. An improved workstation sink including a substantially rectangular container having a front apron panel, a rear panel and pair side panels, the sink including an upper peripheral edge, the front and rear panels having inner walls extending from the peripheral edge to a bottom, each inner wall including an inwardly extending ledge positioned beneath the upper peripheral edge for supporting food preparation accessories, wherein the improvement comprises each ledge including a first portion and a second portion, the first portion extending inwardly from the inner wall at distance beneath the peripheral edge less than that of the second portion, whereby accessories supported from the ledge can be positioned at different elevations.

10. The improved workstation sink in accordance with claim 9 wherein each inner wall includes a lower portion extending upwardly from the bottom and an upper portion which extends downwardly from the peripheral edge with the ledge transitioning between the upper portions and the lower portions.

11. The improved workstation sink in accordance with claim 10 wherein the ledge transitions at a step descending from the upper portion to the lower portion.

12. The improved workstation sink in accordance with claim 9 further including accessories selected from the group consisting of a cutting board, a chopping board, a colander, a drying rack, a drain grid, a soaking vessel and a tray.

13. The workstation sink in accordance with claim 9 wherein the workstation sink is composed of a granite-quartz composition or fireclay.

14. The workstation sink in accordance with claim 9 wherein the first portion of each ledge accommodates a first accessory and the second portion of each ledge accommodates more than one accessory.

15. The workstation sink in accordance with claim 14 wherein the first portion of each ledge carries a cutting or chopping block.

16. The workstation sink in accordance with claim 14 wherein the second portion of each ledge carries a colander and a rack.

17. A workstation sink comprising a substantially rectangular container having a front apron panel, a rear panel and pair side panels, the sink including an upper peripheral edge, the front and rear panels having inner walls extending from the peripheral edge to a bottom, the inner surfaces of each panel including an inwardly projecting ledge for supporting food preparation accessories, each ledge including a first portion and a second portion, the first portion extending inwardly from the inner wall at distance beneath the peripheral edge less than that of the second portion, whereby accessories supported from the ledge can be positioned at different elevations within the workstation sink.

18. The workstation sink in accordance with claim 17 further including accessories selected from the group consisting of a cutting board, a chopping board, a colander, a drying rack, a drain grid, a soaking vessel and a tray.

19. The workstation sink in accordance with claim 17 wherein each inner wall includes a lower portion extending upwardly from the bottom and an upper portion which extends downwardly from the peripheral edge with the ledge transitioning between the upper portions and the lower portions.

20. The workstation sink in accordance with claim 19 wherein the ledge transitions at a step descending from the upper portion to the lower portion.
